(19) United States
(12) Patent Application Publication
(10) Pub. No.: US 2008/0270297 A1
(43) Pub. Date: Oct. 30, 2008

(54) Gathering Information from a Financial Website

(75) Inventors: Alan Wayne McElroy, Bellevue, WA (US); Thomas P. Parrish, Spokane, WA (US); Kelly Birr, Bellevue, WA (US)

Correspondence Address: SADLER, BREEN, MORASCH & COLBY, P.S., 422 W. RIVERSIDE AVE., SUITE 424, SPOKANE, WA, 99201, US

(73) Assignee: PE Systems, Spokane, WA (US)

(21) Appl. No.: 11/740,172

(22) Filed: Apr. 25, 2007

(51) Int. Cl. G06Q 40/00

(52) U.S. Cl. 705/39

(57) ABSTRACT

This document describes tools capable of gathering information from websites of financial institutions. In some embodiments, the tools gather financial statements by automatically navigating through a website for each entity of a group. The tools may then download and save into a single batch all of the financial statements for the group.

### BACKGROUND

In many typical credit-card transactions, a customer purchases a product or service from a company using a VISA®- or MasterCard®-branded credit card. The company receives this transaction through a “merchant,” which is some device or application capable of receiving the customer's card number (e.g., a point-of-sale credit-card reader). To complete the transaction, the merchant receives an authorization from a third party, known as a “merchant processor,” which is sponsored by a VISA®- or MasterCard®-member bank. A company typically selects a merchant processor to install merchants, train the company's staff in the use of the merchants, access the credit-card network for authorizations, and process the company's credit-card transactions.

The merchant processor, through its sponsoring bank, reimburses the company for each transaction after deducting transaction fees retained by the merchant processor. Within these transaction fees are the merchant processor's processing fee, the interchange fees paid to the issuer of the credit card, and the assessment fees that are paid to the credit-card association. The merchant processor submits the net transaction into the card association's settlement network in order to be reimbursed by the issuing bank. The VISA® and MasterCard® associations are responsible for building, operating, maintaining, authorizing, and providing the information required for the member banks to settle their net transaction volume. Each association receives an assessment fee from both the merchant processor's bank and the issuer's bank for each credit-card transaction processed through their respective network. The issuer in turn bills the customer the full amount of the original charge.

Some companies might like to track these transaction fees to see if their merchant processor is overcharging them or to figure out how to reduce these fees. But these fees can be very difficult to track. They can be difficult to track because of the sheer number of transactions received; some companies (or even some merchants) receive hundreds of thousands of transactions a month. Most companies simply do not have the extraordinary manpower or expertise often needed to audit these transactions or any of their various transaction fees.

These transaction fees can also be difficult to track because merchant processors may not want companies to track them. Merchant processors—the companies that have good information about transactions and transaction fees—often have no incentive to help companies track these transaction fees. If a company can track and understand these transaction fees it may better be able to reduce how much it pays—and thus sometimes reduce a merchant processor's revenue.

Merchant processors provide some information, but often do so in ways that make it difficult for companies to track transactions and their fees. In many cases merchant processors provide a statement that lists transactions or groups of transactions, their fees, and other information for each merchant. But they provide these statements through websites that require extensive user interaction and time to gain access to these statements. Also, merchant processors are generally unwilling to provide statements in batches. Many groups of merchants (e.g., companies) may have thousands of merchants and so would like to analyze them in batched form but instead may have to painstakingly navigate through a merchant processor's website thousands of times—once for each merchant.

By way of example, consider a company having 100 merchants. This company may have to do the following to gain access to information about its transactions and transaction fees. First, the company may need a person to select and view the merchant processor's website and enter credentials into the appropriate webpage of the website. Second, the person may have to enter a merchant identification number for that particular merchant. Third, the person may have to navigate through multiple screens (and wait for each to load), before being permitted to select the particular merchant-processor statement for the particular merchant and a particular billing cycle of interest. Fourth, once able to select that statement, the person manually clicks on the statement. Fifth, the person manually selects to agree to a contract presented by the merchant processor to permit download of the statement. Sixth, the person manually selects a location to which to save that statement. Seventh, the person manually selects to save the file to that location. Eighth, the person waits for it to be saved. Ninth, the person navigates back to a webpage permitting entry of a second identification number for a second merchant of the company's 100 merchants. Then the person may proceed to perform steps two through nine over and over again for each merchant from two to 100. In this example of a company having only 100 merchants, a person has to wade through about 900 actions taking many, many hours.

This example in the field of credit-card transactions is just one example of groups wanting to gather financial information. Many other groups would like to more-easily gather information from financial institutions. These groups, like the example companies discussed above, may have difficulty gathering financial information, especially when that information is associated piecemeal with entities within the group, like the 100 merchants associated with the single company as noted above.

Therefore, there is a need in the art to provide better tools for gathering information from financial institutions.

### SUMMARY

This document describes tools capable of gathering information from websites of financial institutions. In some embodiments, the tools gather financial statements by automatically navigating through a website for each entity of a group. The tools may then download and save into a single batch all of the financial statements for the group.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 illustrates an example operating environment in which various embodiments of the tools may operate.

FIG. 2 illustrates an example flow diagram in which the tools act to enable the data-gathering module to provide a user interface (shown) to receive input from a user.

FIG. 3 illustrates an example flow diagram in which the data-gathering module automatically navigates through webpages of the U.S. Credit Processors' website to download and batch credit-card transaction statements for Acme Parking Lot Company's merchants.

FIG. 4 illustrates an example flow diagram providing greater detail on actions performed at arrow 3-2 of FIG. 3.

FIG. 5 illustrates an example process illustrating some ways in which the tools may act to gathering information from websites of financial institutions.

### DETAILED DESCRIPTION

### Overview

The following document describes tools capable of gathering information from websites of financial institutions. In some portions, this document details how the tools may act in the field of credit-card transactions, merchants, and merchant processors, though the tools are applicable in other fields of finance as well. In some of the examples provided below, the tools include an application that is customizable to automate a web browser to interact with one or more financial-institution websites.

An environment in which the tools may enable these and other actions is set forth below in a section entitled Example Operating Environment. This section is followed by User Interface for Receiving User Input, which describes one particular example in which a website data-gathering module provides an example group of entities—the Acme Parking Lot Company with a user interface to receive input, such as input indicating from which financial institution and for which group or billing cycle the company would like batched financial statements. The next section, entitled Gathering Financial Information, continues the Acme Parking Lot Company example to describe ways in which the tools may gather information from websites of financial institutions. A final section describes various other embodiments and manners in which the tools may act and is entitled. Other Embodiments of the Tools. This overview, including these section titles and summaries, is provided for the reader's convenience and is not intended to limit the scope of the claims or the entitled sections.

### Example Operating Environment

Before describing the tools in detail, the following discussion of an example operating environment is provided to assist the reader in understanding some ways in which various inventive aspects of the tools may be employed. The environment described below constitutes but one example and is not intended to limit application of the tools to any one particular operating environment. Other environments may be used without departing from the spirit and scope of the claimed subject matter.

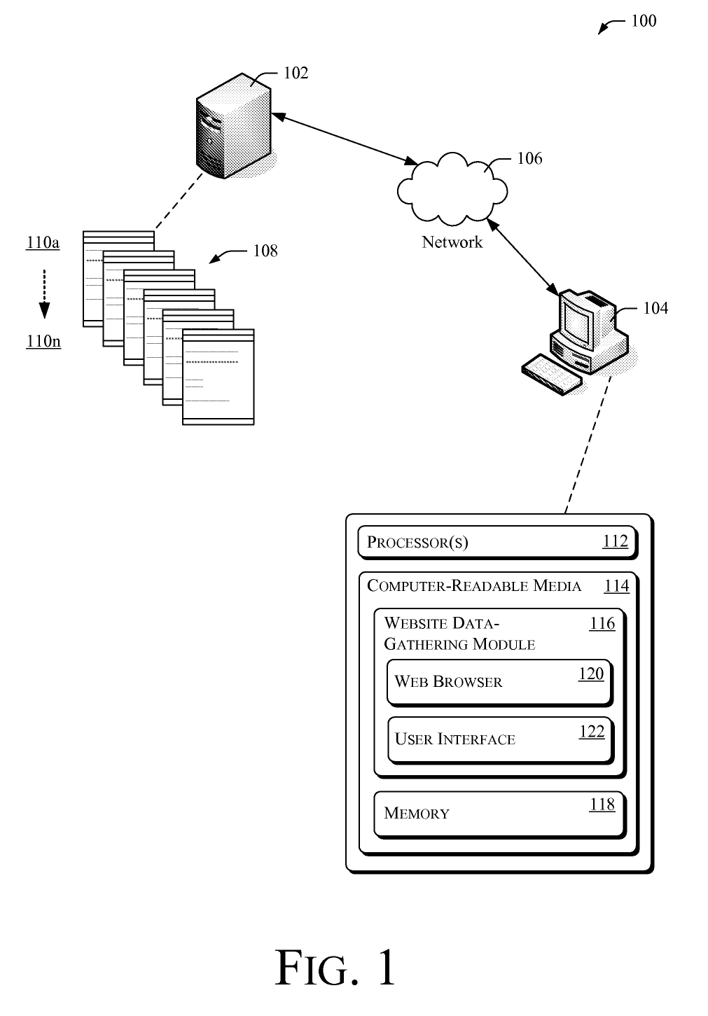

FIG. 1 illustrates one such operating environment generally at 100 having a financial institution's server 102, an entity group's computing device 104, and a communication network 106. Communications between these entities are shown with arrows.

The financial institution's server includes application(s) capable of providing a financial website 108 having webpages 110a through 110n (“n” can be any integer). This financial website provides access to financial statements through these webpages, such as those including information regarding a merchant's credit-card transactions and fees. The financial statements may include text-formatted documents easily readable by humans, such as a document in ASCII text.

The entity group's computing device includes one or more processor(s) 112 and computer-readable media 114. The computing device is shown with a desktop icon, though it may comprise one or multiple computing devices of various types. The processors are capable of accessing and/or executing the computer-readable media.

The computer-readable media includes or has access to a website data-gathering module 116 and memory 118. The website data-gathering module (the “gatherer”) is capable of gathering information from websites over the communications network. The gatherer may store information automatically and/or without user interaction in many cases, some of which are discussed in detail below. To gather and store information, the gatherer may use a web browser 120. When using a web browser the gatherer acts to automate the web browser effective to interact with financial website 108. The gatherer may automate the web browser based on the workflows and requirements of webpages of the financial website.

The gather also includes a user interface 122 through which the gatherer may interact with a user, such as with a person working to access financial statements for an entity group.

Communications network 106 comprises one or more wireless or wired networks, such as a company's wired intranet, the Internet, a LAN, and a cell-enabled wireless network to connect to any of these.

Because many of the examples described herein concern credit-card transactions, the discussion briefly explains some terms often used in these examples. The term “merchant” is one type of entity that may have associated with it a financial statement, such as a merchant-processor statement. The term “company” is an example of a group of entities (or an “entity group”). The term “credit” includes credit, debit, and other accounting systems so long as they are processed by a credit or debit association (e.g., VISA® and MasterCard®. The term “card” applies to any medium or manner in which sales or purchases may be electronically transacted, such as a card having a magnetic strip, a card having circuitry, a credit account not having any physical element, or a key-faub that electromagnetically identifies an account. Thus, a credit-card transaction is one that involves a customer of a merchant purchasing a product or service through some accounting system processed by a credit or debit association. Information about credit-card transactions may include, for each purchase or groups of purchases, the purchase price(s), the date(s) of the purchase(s) or date(s) that the purchase(s) were batched by the merchant, card-issuer interchange categories, fees, or rates for the purchase(s), and through which credit-card association's network the purchase(s) were made (e.g., VISA® or MasterCard®. The data may also indicate each purchase and its interchange category or groups of purchases by their interchange category.

### User Interface for Receiving User Input

This section describes one particular example in which the website data-gathering module (again, the “gatherer”) provides a user interface to receive input from a user. This input may indicate from which financial institution and for which group or period a user would like batched financial statements. This example is an implementation of the tools but is not intended to limit the scope of the tools or the claimed embodiments.

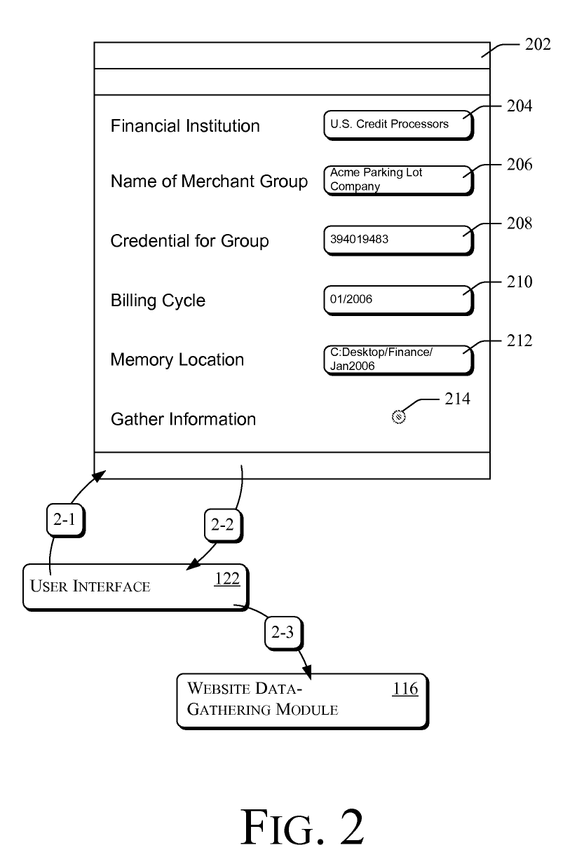

This example is illustrated in FIG. 2, which shows actions and interactions of and between a user and elements of FIG. 1, namely user interface 122 and gatherer 116, as well as some results of these actions and interactions.

At arrow 2-1 in FIG. 2, user interface 122 provides an interface screen 202 having data-entry fields and a selectable control. This example includes merchants and groups of merchants. A merchant is some entity, such as a credit-card reader, capable of receiving credit-card transactions and batching these transactions. Thus, a group of merchants (e.g., a business or client) may include hundreds or even thousands of merchants.

In this example we assume that the group of merchants is a single business entity—Acme Parking Lot Company—having a credit-card reader at each parking lot, online monthly sales input through a computer application, and portable credit-card readers, all of which total 211 merchants.

The interface screen includes a financial institution data-entry field 204 into which a user may enter a particular bank, merchant processor, or other institution from which financial statements are desired. Here Acme's user enters “U.S. Credit Processors”—a company that processes credit-card transactions for Acme.

The interface screen also includes a name data-entry field 206 into which the user enters “Acme Parking Lot Company”. The user also enters a credential for Acme into credential data-entry field 208 (“394019483”). This credential is sufficient for U.S. Credit Processors to permit access to financial statements (here each a merchant processor's credit-card transaction statement) for all of Acme's merchants.

Billing cycle data-entry field 210 permits Acme to enter which statements are desired, such as a month of the year. Here the user enters 01/2006, which indicates a statement for all of January 2006.

The interface screen also includes a memory location data-entry field 212 into which the user indicates a location in memory to which the user would like statements for all of Acme's merchants to be batched. The user selects, through a file browser, C:Desktop/Finance/Jan2006.

The user then selects gather-information control 214, which indicates to the user interface that the user desires to commence gathering the information.

At arrow 2-2 the user interface receives the user's input. It provides this to gatherer 116 at arrow 2-3. After receiving this information, the gatherer gathers credit-card transactions statements from the U.S. Credit Processors' website for all 211 merchants associated with Acme Parking Lot Company.

### Gathering Financial Information

This section describes one particular example in which the tools gather information from websites of financial institutions. This section is described in the context of the ongoing credit-card transaction example, though the tools may act in other manners as well.

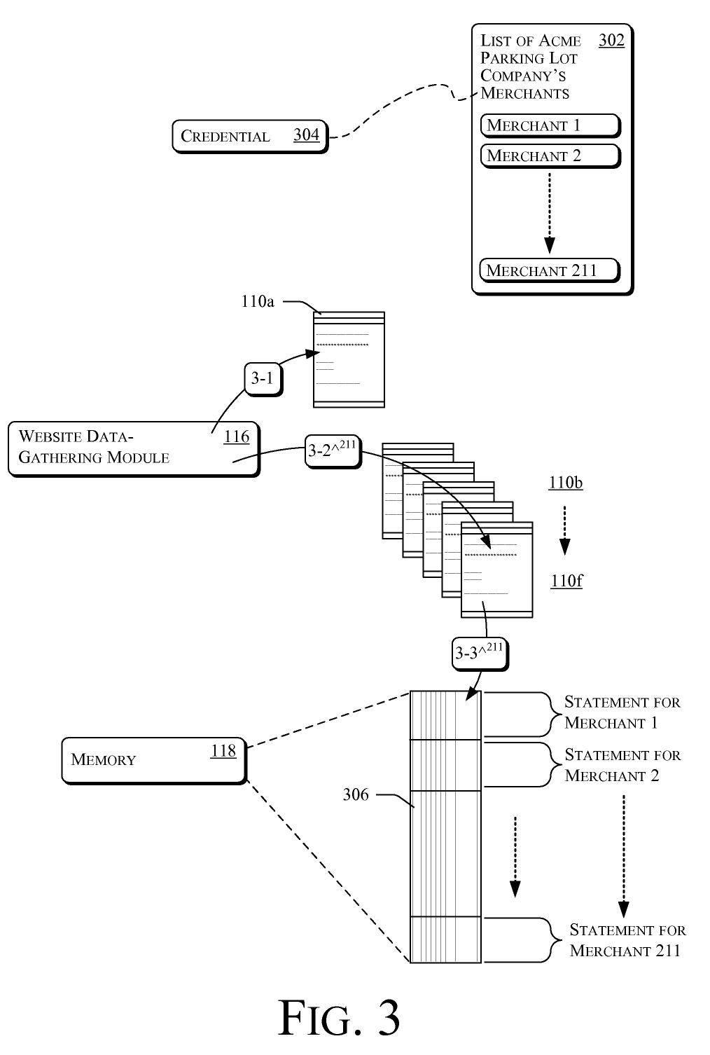

In this section the gatherer automatically navigates through webpages of U.S. Credit Processors' website by selecting, entering information (e.g., Acme's credential and a particular billing cycle), and waiting. By so doing, the gatherer interacts with this merchant-processor's website to gather credit-card transaction information for all of Acme Parking Lot Company's merchants. A list of Acme's merchants is shown in FIG. 3 at 302. This list illustrates that Acme has 211 merchants numbered 1 to 211. It also illustrates that all of Acme and its merchants are associated with a single credential 304.

At arrow 3-1, a user or the gatherer navigates to webpage 110a in which a credential may be input. If the user navigates to the webpage he or she inputs a credential associated with the merchant group (“394019483”), validation of which permits access to merchant-processor credit-card transaction statements for all of the merchants. Continuing the prior example, however, the gatherer instead automatically navigates to this webpage 110a and enters this credential. Once approved, the gatherer proceeds to arrow 3-2.

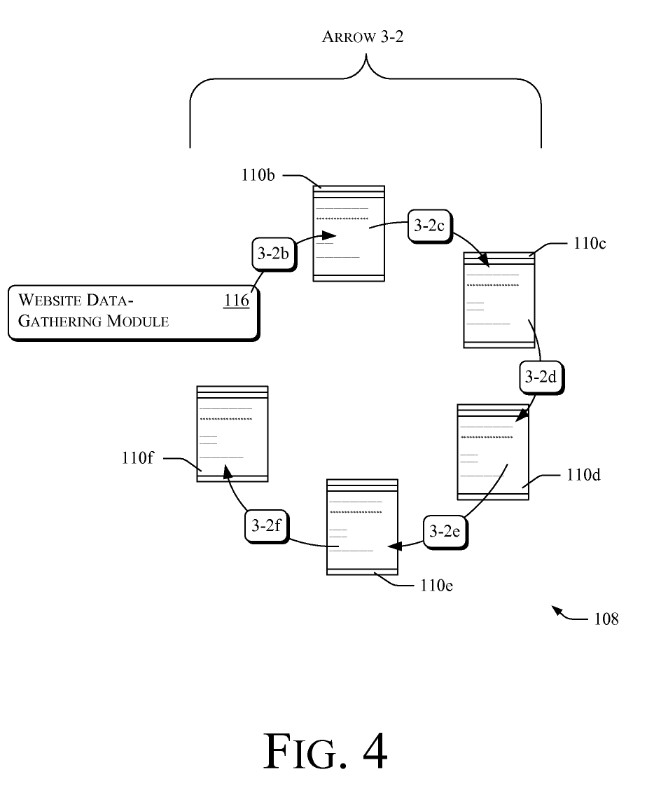

At arrow 3-2, the gatherer navigates through webpages of the merchant-processor's website until the gatherer is permitted to download a statement for a particular merchant and for a particular billing cycle. The gatherer may repeat this navigation 211 times to download all 211 statements. To better visualize how the gatherer may navigate, the merchant-processor's webpages 110b through 110f are illustrated in FIG. 4.

FIG. 4 shows, in greater detail, example actions included in arrow 3-2. Here the gatherer navigates and interacts with the merchant processor's website 108 through selecting, entering information, scrolling with slider bars, and the like.

At arrow 3-2b (the “b” indicating interaction with webpage 110b), the gatherer navigates to webpage 110b. Webpage 110b requires that the group of merchants agree to a contract. To agree to the contract, the gatherer must select a slider-bar, slide down to the bottom of the contract at which point a “Yes” button appears, and select the “Yes” button. After the gatherer agrees to the contract, the gatherer proceeds to webpage 110c.

At arrow 3-2c, the gatherer interacts with webpage 110c. Webpage 110c requires selection of a particular merchant of the group of merchants. As noted above, Acme Parking Lot Company has 211 merchants. The gatherer references its database (e.g., the list 302) to find a merchant identifier for the first of the 211 merchants, enters that identifier into a data-entry field in webpage 110c, and selects “Enter” or “Tab”. The gatherer waits for website 108 to approve the merchant identifier, after which the gatherer may proceed to webpage 110d.

At arrow 3-2d, the gatherer proceeds to webpage 110d. Webpage 110d requires that a merchant group select which billing cycle is desired. The gatherer draws from the data input by the user in FIG. 2 and proceeds to enter “01/2006” into a data-entry field provided in webpage 110d. The gatherer then selects “Enter” or “Tab”, waits for the website 108 (waiting on applications running on server 102) to approve, and then is permitted to proceed to webpage 110e.

At arrow 3-2e, the gatherer proceeds to webpage 110e. Webpage 110e requires entry of a location in memory to which the website will save the statement for the first merchant of 211 merchants and having the billing cycle entered. The gatherer draws this information (here received in FIG. 2) from a database and enters “C:Desktop/Finance/Jan2006” into a data-entry field provided in webpage 110e. The gatherer may instead select a control in webpage 110e by which to browse through a local file folder system of computing device 104 to select this same memory location.

At arrow 3-2f, the gatherer proceeds to webpage 110f, which presents a merchant-processor credit-card transaction statement in a human-readable text format. Consider the following example statement, which includes credit-card transaction data for one merchant and for one billing cycle:

Jan. 31, 2006 1923 1923920009
Merchant Processor
Merchant Processor's Address
Merchant Processor's Identification Number
Merchant
Merchant's Address
Merchant's Identification Number: 932734932

PLAN SUMMARY

| PL | #SALES | $SALES | #CREDITS | $CREDITS | NET SALES | AVG TKT | DISC P/I | % | DISCOUNT DUE |
|---|---|---|---|---|---|---|---|---|---|
| V | 997 | 52,203.43 | 26 | 925.68 | 51,277.75 | 52.36 | .130 | .000 | 129.61 |
| M | 1574 | 77,488.14 | 40 | 1,180.06 | 76,308.08 | 49.23 | .130 | .000 | 204.62 |
| DS | 298 | 16,210.99 | 17 | 583.77 | 15,627.22 | 54.40 | .000 | .000 | .00 |
| ** | 2869 | 145,902.56 | 83 | 2,689.51 | 143,213.05 | 50.85 | | | 334.23 |

| DAY | REF NO. | * | PL | #SALES | $SALES | $CREDITS | DIS.PD | NET DEPOSIT |
|---|---|---|---|---|---|---|---|---|
| 01 | 52106000034 | D | T | 76 | 3,695.36 | 136.59 | .00 | 3,558.77 |
| 02 | 52106100038 | D | T | 73 | 4,028.78 | 39.33 | .00 | 3,989.45 |
| 03 | 52106200038 | D | T | 64 | 4,709.22 | .00 | .00 | 4,709.22 |
| 04 | 52106300037 | D | T | 95 | 4,131.47 | 87.09 | .00 | 4,044.38 |
| 06 | 52106400038 | D | T | 97 | 4,440.53 | 119.75 | .00 | 4,320.78 |
| 06 | 52106500036 | D | T | 149 | 9,125.75 | 84.94 | .00 | 9,040.81 |
| 07 | 52106600038 | D | T | 63 | 2,500.94 | 57.31 | .00 | 2,443.63 |
| 08 | 52106700037 | D | T | 92 | 4,395.07 | 150.35 | .00 | 4,244.72 |
| 09 | 52106800038 | D | T | 77 | 3,466.22 | 54.15 | .00 | 3,412.07 |
| 10 | 52106900038 | D | T | 78 | 3,445.58 | 18.05 | .00 | 3,427.53 |
| 11 | 52107000037 | D | T | 87 | 3,442.52 | 65.83 | .00 | 3,376.71 |
| 13 | 52107100037 | D | T | 87 | 4,151.55 | 358.95 | .00 | 3,792.60 |
| 13 | 52107200037 | D | T | 117 | 6,766.41 | 5.29 | .00 | 6,761.12 |
| 14 | 52107300036 | D | T | 88 | 4,406.70 | 63.72 | .00 | 4,342.98 |
| 15 | 52107400038 | D | T | 76 | 2,070.91 | 35.54 | .00 | 2,035.37 |
| 16 | 52107500038 | D | T | 94 | 4,606.75 | 62.78 | .00 | 4,543.97 |
| 17 | 52107600036 | D | T | 90 | 3,568.66 | 7.43 | .00 | 3,561.23 |
| 18 | 52107700040 | D | T | 122 | 5,764.02 | 174.37 | .00 | 5,589.65 |
| 20 | 52107800038 | D | T | 119 | 5,803.97 | 44.70 | .00 | 5,759.27 |
| 21 | 52108000039 | D | T | 230 | 15,854.65 | 32.97 | .00 | 15,821.68 |
| 22 | 52108100040 | D | T | 111 | 5,544.80 | 232.06 | .00 | 5,312.74 |
| 23 | 52108200037 | D | T | 93 | 4,199.12 | 141.67 | .00 | 4,057.45 |
| 24 | 52108300040 | D | T | 76 | 2,660.72 | 128.79 | .00 | 2,531.93 |
| 25 | 52108400038 | D | T | 71 | 2,764.74 | 12.74 | .00 | 2,752.00 |
| 27 | 52108500040 | D | T | 112 | 7,216.82 | 39.55 | .00 | 7,177.27 |
| 27 | 52108600038 | D | T | 134 | 7,511.06 | 219.85 | .00 | 7,291.21 |
| 29 | 52108800040 | D | T | 107 | 5,101.36 | 134.45 | .00 | 4,966.91 |
| 31 | 52109000040 | D | T | 191 | 10,528.86 | 181.26 | .00 | 10,347.60 |

| | | | | | |
|---|---|---|---|---|---|
| DEPOSIT TOTALS | 2,869 | 145,902.56 | 2,689.51 | .00 | 143,213.05 |

AMOUNT DEDUCTED FROM ACCOUNT 2,725.61

| FEES | | | |
|---|---|---|---|
| NUMBER | AMOUNT | DESCRIPTION | TOTAL |
| | | SUPPORT PACKAGE | 5.95 |
| 02 | 14.00 | TERMINAL FEE | 28.00 |
| 10 | 586.95 | VISA ® STANDARD (2.63% XSALES + $.10XITEMS) | 16.44 |
| 350 | 12,452.24 | VISA ® RTL CK DB (1.05% XSALES + $.15XITEMS) | 183.25 |
| 461 | 27,404.65 | VISA ® CPS RETAIL (1.54% XSALES + $.10XITEMS) | 468.13 |
| 57 | 3,431.71 | VISA ® EIRF (2.14% XSALES + $.10XITEMS) | 79.14 |
| 16- | 662.12- | VISA ® CREDIT CONSUMER CARD @ 1.67% | 11.06- |
| 01- | 6.37- | VISA ® CREDIT COMMERCIAL CARD @ 2.24% | .14- |
| 47 | 1,716.92 | VISA ® EIRF DB (1.75% XSALES + $.20XITEMS) | 39.45 |
| 02 | 92.90 | VISA ® STANDARD DB (1.90% XSALES + $.25XITEMS) | 2.27 |
| 09- | 257.19- | VISA ® CV-CNSR DB (1.31% XSALES) | 3.37- |
| | 52,203.43 | VISA ® DUES AND ASSESSMENTS (0.925% XSALES) | 48.29 |
| 10 | 1,577.69 | MC STANDARD (2.70% XSALES + $.10XITEMS) | 43.60 |
| 522 | 32,284.36 | MC MERIT 3 (1.54% XSALES + $.10XITEMS) | 549.38 |
| 06 | 1,579.45 | MC KEY ENTERED (1.90% XSALES + $.10XITEMS) | 30.61 |
| 81 | 3,821.95 | MC CORP DATA RT1 (2.65% XSALES + $.10XITEMS) | 109.38 |
| 16 | 604.03 | MC STANDARD DB (1.90% XSALES + $.25XITEMS) | 15.48 |
| 10 | 203.57 | MC KEY ENTER DB (1.64% XSALES + $.16XITEMS) | 4.94 |
| 929 | 37,417.09 | MC MERIT 3 DB (1.05% XSALES + $.15XITEMS) | 532.23 |
| 19- | 371.74- | MC CONS DB RF 3 @ 1.40% | 5.20- |
| 19- | 668.64- | MC CONS CR RF 4 @ 1.77% | 11.83- |
| 02- | 139.68- | MC CORP CR RF 3 @ 2.15% | 3.00- |
| | 77,488.14 | MC DUES AND ASSESSMENTS (.095% XSALES) | 73.61 |
| 65 | 6,311.88 | VISA ® BUS ELECT (2.20% XSALES + $.10XITEMS) | 145.36 |
| 05 | 206.18 | VISA ® BUS STD (2.70% XSALES + $.10XITEMS) | 6.07 |
| 296 | | DISCOVER AUTHORIZATIONS @ 15 CENTS | 44.40 |
| | | OTHER FEES DUE | 2,391.38 |

| | |
|---|---|
| DISCOUNT DUE | 334.23 |
| OTHER FEES DUE | 2,391.38 |
| AMOUNT DEDUCTED | 2,725.61 |

Legend
CARD PLAN CODES
VD—VISA ® DEBIT CARD
VB—VISA ® BUSINESS CARD
M—MASTERCARD ®
MB—MASTERCARD ® BUS. CARD
P1—PRIVATE LABEL PLAN 1
P2—PRIVATE LABEL PLAN 2
P3—PRIVATE LABEL PLAN 3
VA—VISA ® CASH
MA—MASTERCARD ® CASH
VL—VISA ® LARGE TICKET
ML—MCS LARGE TICKET
DB—DEBIT CARD
JB—JCB
DC—DINERS CLUB CARD
DS—DISCOVER
AM—AMERICAN EXPRESS
V—VISA ®
TRANSACTION PLAN CODES
V—VISA ®
M—MASTERCARD ®
P—PRIVATE LABEL
L—LARGE TICKET
T—ALL PLANS
1—PLAN ONE
2—PLAN TWO
3—PLAN THREE
A—CASH ADVANCE
D—DEBIT
B—BUSINESS CARD
TRANSACTION TYPE CODES
D—DEPOSIT
C—CHARGEBACK
A—ADJUSTMENT
B—CHARGEBACK REVERSAL

Referring back to FIG. 3, the gatherer, at arrow 3-3, saves this statement (and later the other 210 statements) into a single batch 306 at the selected memory location. The gatherer repeats arrows 3-2b through 3-2f until it has downloaded all of the merchant-processor credit-card transaction statements for January, 2006 for all 211 merchants associated with Acme Parking Lot Company. The gatherer may perform all of these actions automatically and with little or no user interaction. A user may have performed one action-navigating to webpage 110a and entering Acme's credential. Or a user may have done nothing, except possibly interacting with the user interface in FIG. 2.

Saving these statements into a batch is illustrated with memory 118 showing a database of statements for merchants 1 through 211 of Acme Parking Lot Company. Here the statements are simply appended to each other in the batch, though the information from these statements may be collected and categorized in various other ways.

As noted in FIG. 3, the gatherer performs actions for arrows 3-2 and 3-3 211 times. This is noted with a superscript of “̂²¹¹” for these arrows.

### Other Embodiments of the Tools

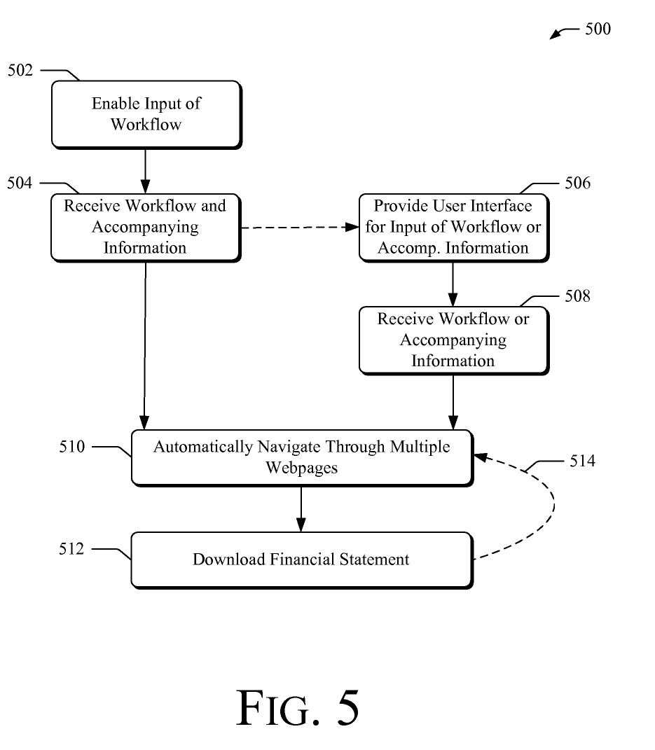

The above sections describe particular examples where the tools provide a user interface to receive input and gather information from websites of financial institutions for Acme Parking Lot Company. In this section these and other embodiments of the tools are described using processes 500 of FIG. 5. Process 500 describes ways in which the tools may gather financial information from a financial website, which in some cases includes enabling a user to customize the website data-gathering module to a particular website.

This process and the example flow diagrams described and illustrated in FIGS. 2 through 4 may be implemented in any suitable hardware, software, firmware, or combination thereof; in the case of software and firmware, these processes represent sets of operations implemented as computer-executable instructions stored in computer-readable media and executable by one or more processors (e.g., processor(s) 112 and computer-readable media 114). These embodiments of the tools described in this section are not intended to limit the scope of the tools or the claims.

The tools may interact with many different websites from many different financial institutions effective to download financial information in batches. To interact with different websites, the tools may enable a user to customize website data-gathering module 116 for each of these websites. Process 500 of FIG. 5 illustrates ways in which the tools may act and interact with a user to enable this customization, as well as other actions.

Block 502 enables a user to input a workflow of a financial institution's website. This workflow may include web addresses for webpages of the website, actions needed to navigate through the webpages, and the like. This workflow maps out the website effective to enable the tools to navigate through the webpages. The user may input this workflow manually, such as by inputting webpage addresses and actions (e.g., clicking on a control or entering credentials). The tools may also enable a user to navigate through a website while recording the user's actions.

A user may, for example, open an investment-banking website, enter credentials for a company, and navigate through the website to view and download one or more retirement-account statements for employees of the company. In this case the employees are entities associated with a group (here the “company”). Whether manually or by recoding navigation, the tools enable a user to input a workflow and the actions needed to navigate through and download financial information from a particular website.

In the above example involving credit-card transactions and Acme Parking Lot Company, for example, the gatherer may have enabled a user to manually navigate through the U.S. Credit Processors' website and record the user's actions, such as into which data-entry fields data is entered, what data is entered, such as credentials and billing cycles, and other actions needed to navigate through the website. The gatherer records the user's manual navigation for later use. This is one way in which the tools may act so that gatherer 116 may automatically navigate through financial institution's website 108, such as is described in the Acme example.

This workflow may include all of the navigation needed so that the gatherer may automatically navigate through a website without any user interaction, but it may exclude some actions as well. A user may input only the navigation needed after a certain point, if desired. Thus, a user may forgo logging into the website with its credentials when inputting the workflow, and instead have the workflow perform all actions after a user has manually logged in. In the Acme and the investment-banking examples, the user would then navigate manually to a website, enter credentials, wait until the credentials are accepted and a new webpage is loaded, and then select that the gatherer automatically do everything else. In the Acme example this would mean that a user would manually perform arrow 3-1 and the gatherer would perform arrows 3-2 and 3-3 two hundred and eleven times (once for each merchant).

If the user inputs enough information regarding the website's workflow, the tools may not need any information from the user prior to downloading information from the financial institution's website. If the workflow includes the credentials, a selection to gather information at intervals (e.g., every month), and a location in memory to store the information, for example, the tools may gather the information at each interval on an ongoing basis and without user input. Alternatively, the tools may be custom-built by a programmer and so skip all or some of blocks 502-508. In any of these cases, however, the tools are capable of automatically navigating through websites to download financial information in batch form.

Block 504 receives the workflow and accompanying information for later use in automatically navigating through the website at issue. As noted above, the tools may rely on some information from a user prior to navigating and downloading financial information. This may simply be a selection to begin the download, e.g., just the gather-information selectable control 214 of FIG. 2. The tools may also provide a user interface for additional information, e.g., with data-entry fields 204-212 of FIG. 2.

Thus, if interaction with a user is needed prior to downloading financial statements, the tools proceed to block 506. If this is not needed, the tools skip blocks 506 and 508 and proceed to block 510.

Block 506 provides a user interface having selectable controls and/or data-entry fields through which a user may interact with the tools. These controls/data-entry fields may include a data-entry field enabling entry of a credential usable by a financial institution to validate a group of entities, a data-entry field enabling entry of an electronic storage location (e.g., a local memory location), an indication of a period (a “period indicator”), such as a billing cycle, a name of the financial institution, and a name of the group of entities, to name a few. The selectable controls may include a button to select to begin downloading or a selectable list of financial institution websites and the like. An example user interface is shown in FIG. 2.

Block 508 receives input from a user, such as information entered into data-entry fields provided at block 506. This information may indicate which or how many periods for which a group would like batched financial statements, such as the last 12 billing cycles, this quarter's retirement-account interest, and the like. Based on this information the tools may proceed to block 510.

Block 510 automatically navigates through multiple webpages of a financial institution's website. Block 510 may act responsive to a user's selection, such as selection of a selectable control provided at block 506 and received at block 508. Block 510 may also act without user interaction, such as every month, either responsive to block 504 or otherwise.

Block 510 navigates and interacts with the website effective to download financial statements (at block 512), such as retirement-account statements for a company's employees' 401(k) accounts or credit-card transaction statements for a group's merchants. The tools may navigate to a webpage enabling download (a “download webpage”) of a financial statement. This webpage may present the statement in the webpage or enable download without presentation. An example webpage that enables download and presents the statement is described above at 110f in FIG. 4. The tools may download a financial statement for every entity associated with a group automatically, automatically in response to a single user selection, or automatically in response to entry of various pieces of information into a user interface. In doing so, the tools navigate through webpages according to a workflow mapping those webpages.

The tools may save these statements in batches by appending the statements or by selecting portions of the statements and rearranging them into another format. The tools may download the statements to a temporary memory location, for example, and then perform an Extract Transform and Load (ETL) process to extract desired information, transform it into a different format (e.g., a more easily machine-consumable format), and load into a batch at memory 118.

To perform block 510, the tools may rely on website data-gathering module 116, set forth in FIG. 1. This gatherer may automate actions of web browser 120 or may act as a stand-alone application. If the gatherer is a stand-alone application, it may not use a web browser but may instead navigate and perform other browser-like functions without reliance on a pre-existing web browser. If the gatherer relies on a pre-existing web browser, it may use one of many currently available web browsers, such as Internet Explorer™, Firefox™, and Netscape Navigator™, to name a few.

By way of example, the tools may navigate to a first webpage (e.g., a home page of the website requiring credentials), enter the credentials for a particular group of entities, select to agree to a contract, select controls and the like to move through to other pages, select each entity or proceed through a preordered list of entities, select a particular billing cycle or other period, select a location for the financial statements, and select to download and save financial statements for each entity for that period. An example of some actions performable by the tools is set forth in the Acme example above (see FIG. 4).

Block 512 downloads a financial statement for an entity of the group into a memory location. The tools may save all of the financial statements into a batch, such as similar to batch 306 of FIG. 3. In the retirement-account example above, the tools would download an employee's monthly or quarterly retirement-account statement.

The tools repeat any portions of this process needed to download all of the financial statements for entities associated with the group. This is shown with dashed arrow 514. As shown here, the tools repeat blocks 510 and 512 until all of the financial statements are downloaded and batched in a particular memory location, such as one received from a user at block 508.

The tools may act through the gatherer and save into a single batch all of these statements onto a disk. In the context of retirement accounts, this financial information may be used to track how well each employee's or all of the company's participating employees' retirement accounts are gaining or losing value, what investments are being made, the withdrawal rate, the retirement-account manager's fees, and the like.

In the context of credit-card transactions, this financial information may be used to track fees and transactions. In the Acme example, the tools enable Acme Parking Lot Company to track and better understand its finances, such as whether the fees charged by U.S. Credit Processors are correct or perhaps just to better understand them. This is enabled by the tools performing what would otherwise likely be an extremely long and tedious process for a person to do manually.

The tools may also enable a group of entities, with very little or even no interactions with the website other than mapping its workflow, to build a history of financial statements. In the above Acme example, for instance, the tools may batch 211 financial statements for many historic billing cycles, such as for the last 24 months. This would amount to the gatherer automatically batching 5,064 financial statements with selection of a single button.

### CONCLUSION

The above-described tools are capable of gathering information from websites of financial institutions, such as by automatically navigating through a website for each entity of a group. The tools may then download and save into a single batch all of the financial statements for the group. This may save hours if not days of tedious labor, thereby permitting groups to more easily track their financial information. Although the tools have been described in language specific to structural features and/or methodological acts, it is to be understood that the tools defined in the appended claims are not necessarily limited to the specific features or acts described. Rather, the specific features and acts are disclosed as example forms of implementing the tools.

1. One or more computer-readable media having computer-readable instructions therein that, when executed by a computing device, cause the computing device to perform acts comprising:
automatically navigating through multiple webpages of a financial institution's website to reach a first download webpage enabling download of a first human-readable text-format financial statement for a first entity associated with a group of entities, access to the download webpage requiring prior entry and validation of a credential for the group of entities;
downloading the first financial statement for the first entity;
automatically navigating through multiple webpages of the financial institution's website to reach a second download webpage enabling download of a second human-readable text-format financial statement for a second entity associated with the group of entities, access to the download webpage requiring prior entry and validation of the credential for the group of entities; and
downloading the second financial statement for the second entity,
the acts of downloading effective to save into a single batch the first and second financial statements.

2. The media of claim 1, further comprising providing a selectable download control and receiving selection of the download control, and wherein all of the acts of navigating and downloading are responsive to receiving the selection and without user interaction other than receiving selection of the download control.

3. The media of claim 1, wherein the group of entities comprises one or more other entities and further comprising, for each of the other entities:
automatically navigating through multiple webpages of the financial institution's website to reach another download webpage enabling download of another human-readable text-format financial statement for the other entity associated with the group of entities, access to the download webpage requiring prior entry and validation of the credential for the group of entities; and
downloading the other financial statement for the other entity effective to save the other financial statement into the single batch.

4. The media of claim 1, further comprising, prior to the act of downloading the first financial statement, automatically entering the credential into the financial institution's website.

5. The media of claim 1, further comprising, prior to the act of downloading the first financial statement, providing a data-entry field into which a user may enter the credential, receiving the credential into the data-entry field, and entering the credential into a webpage of the financial institution's website.

6. The media of claim 1, wherein the act of automatically navigating through multiple webpages to reach the first download webpage comprises entering the credential into one of the multiple webpages.

7. The media of claim 1, wherein all of the acts of navigating and downloading are performed without user interaction.

8. The media of claim 1, wherein at least one the multiple webpages navigated through as part of the first or second act of navigating requires selection and agreement to a contract.

9. The media of claim 8, wherein the first and second acts of automatically navigating comprise automatically selecting and agreeing to the contract.

10. The media of claim 1, wherein at least one the multiple webpages navigated through as part of both the first and second acts of navigating requires entry of a location into which a financial statement is to be downloaded.

11. The media of claim 10, wherein the first and second acts of automatically navigating comprise automatically entering the location.

12. The media of claim 1, wherein the acts of downloading the financial statements saves the financial statements into the single batch in an easily machine-consumable format.

13. The media of claim 1, wherein the financial institution is a merchant processor, the financial statements are merchant-processor credit-card transaction statements, and the entities are credit-card merchants.

14. A method implemented at least in part by a computing device comprising:
providing a first data-entry field enabling entry of a credential, a second data-entry field enabling entry of an electronic storage location, and a third data-entry field enabling entry of a period indicator;
receiving a credential into the data-entry field, the credential associated with a group of entities;
receiving entry of an electronic storage location into the second data-entry field;
receiving entry of a period indicator into the third data-entry field; and
automatically navigating to and entering into webpages of a financial institution's website the received credential, the received electronic storage location, and the received period indicator effective to download and save into a batch at the received location a financial statement for each of multiple entities associated with the group of entities and for a period associated with the period indicator.

15. The method of claim 14, wherein the act of navigating to and entering into webpages enters the received electronic location once for each of the financial statements.

16. The method of claim 14, wherein the act of navigating to and entering into webpages enters the received period indicator once for each of the financial statements.

17. The method of claim 14, further comprising providing a selectable download control and receiving selection of the download control, and wherein the act of navigating and entering is responsive to receiving the selection of the download control.

18. The method of claim 14, wherein the financial institution is a merchant processor, each financial statement is a merchant-processor credit-card transaction statement, the multiple entities are credit-card merchants, and the period indicator indicates a billing cycle.

19. One or more computer-readable media having computer-readable instructions therein that, when executed by a computing device, cause the computing device to perform acts comprising:
receiving a credential associated with a group of entities;
entering the credential into a webpage of a financial institution's website; and
navigating, automatically and without user interaction, through multiple webpages for each entity of the group of entities effective to download and save a financial statement for each entity.

20. The media of claim 19, further comprising, without user interaction, performing the acts of entering and navigating for successive periods effective to download and save other financial statements for each entity, the other financial statements for the successive periods.

21. The media of claim 20, wherein the act of navigating comprises entering into the multiple webpages of the financial institution's website and for each entity a single period indicator for each successive billing cycle.

22. The media of claim 19, wherein the act of navigating comprises entering into the multiple webpages of the financial institution's website and for each entity a single electronic storage location into which the financial statements are saved.

23. The media of claim 19, wherein the act of navigating downloads the statements for each entity into a temporary memory location and performs an Extract Transform and Load (ETL) process to: extract desired information from the statements; transform the information into an easily machine-consumable format; and load the transformed information into a single batch.

24. The media of claim 19, wherein each financial statement is a merchant-processor credit-card transaction statement and each entity is a credit-card merchant.
